(19) United States
(12) Patent Application Publication
(10) Pub. No.: US 2006/0151337 A1
(43) Pub. Date: Jul. 13, 2006

(54) Electrocoagulation Reaction Chamber

(76) Inventor: F. William Gilmore, Castle Rock, CO (US)

Correspondence Address: KYLE W. ROST, 5490 AUTUMN CT., GREENWOOD VILLAGE, CO, 80111, US

(21) Appl. No.: 10/905,495

(22) Filed: Jan. 7, 2005

(51) Int. Cl. B23H 3/04; C02F 1/461

(52) U.S. Cl. 205/751; 204/286.1

(57) ABSTRACT

A frame carries an electrode stack on pivots so that the stack can be assembled and maintained in horizontal position and operated for treating a fluid stream in vertical position with upward flow. Plates of the electrode stack are lined on minor edges by molded-on, non-reactive extensions to protect against wear during the reaction process. The extensions carry integral interplate spacer portions and integral interplate seal portions to eliminate misplacement of electrode stack elements during assembly and maintenance.

### TECHNICAL FIELD

The invention generally relates elements used in electrical and wave energy chemistry. More specifically, the invention relates to electrolytic apparatus composed of electrodes with an electrode supporting means consisting of a dielectric gasket or spacer. In a further aspect, the invention relates to an electrolytic apparatus and method that employ parallel plate electrodes to form plural separate treatment chambers or zones, with a feeding or withdrawing means providing a flow of liquid to be treated to the cells.

### BACKGROUND ART

The practice of electrolysis upon aqueous solution results in production of water and an agglomerate. The latter can be separated from the water to produce clean water. This process and its chemistry are well known. Many types of apparatus are used to practice electrolysis.

A generally high cost of treatment is a primary problem in using an electrolytic process to produce clean water. The direct cost of electricity is one significant part of the overall cost. The amount of electricity used in electrolytic processing is variable according to many factors in the design of an electrolytic reaction chamber. The reaction rate tends to be diminished by formation of an electrical double layer, characteristically formed whenever DC current is applied across an anode and a cathode. Adequate turbulence in the reaction chamber is helpful to improve the reaction rate, clean the plates, and minimize the effects of the electrical double layer. Design features that increase efficiency and thereby reduce electrical consumption are beneficial.

Maintaining the electrode stack can be a high cost. Electrode plates are consumed by the electrolytic reaction. Their consumption is basic to the chemistry of the reaction. Although the reaction is expected to occur, reaction conditions can vary in unpredictable ways. Even with careful maintenance, an electrolytic cell can become inefficient without warning. One unpredictable cause of inefficiency is wear on the electrode plates at various fluid passages formed in the plates. Such wear can alter the size of the passages, thereby changing fluid velocity inside the reaction chamber.

Changes in fluid velocity can influence fluid retention time in a reaction chamber. Proper retention time strongly influences power consumption. Too much retention time leads to coagulation and floc production within the reaction chamber. Floc buildup diminishes the available electrode area for conducting the reaction, and eventually floc can cause an electrical short in a reaction chamber. Too little retention time may result in incomplete treatment, such that coagulation, sterilization, or like desirable result may fail to be achieved.

The proper level of applied power is determined as a function of reaction rate. If a reaction rate slows unexpectedly, too much power may be applied to the reaction chamber. As a result, the electrode plates wear at excessive rate and will need premature replacement. Overpowering also produces in excessive floc. Too little applied power can result in an incomplete or overly slow reaction, leading to a failed treatment, a reaction that takes excessive time, or a reaction that completes only outside the reaction chamber.

As electrodes wear and are consumed, electrodes also can be fouled or short-circuited by a deposit of reaction products such as floc that is not purged during the processing cycle. An electrolytic reaction can diminish over time due to a buildup on the plates. The buildup tends to harden on the plates under heat caused by the electrical current on the plates.

A fouled electrode becomes prematurely inefficient and can add to the amount of electricity consumed. Fouling causes uneven wear and will require premature replacement or removal of plates for cleaning, either of which adds to maintenance cost and downtime for the reaction chamber. The design of a reaction chamber should keep the reaction products from settling-out or depositing on the electrodes while the process fluid is within the reaction chamber.

A desirable design of a reaction chamber should maintain the process fluid in turbulent flow within the reaction chamber. Turbulence helps to clean the plates of coagulation buildup. In addition, turbulence enhances the electrical reaction by reducing the double electrical barrier that forms when water passes between an anode and cathode with DC current applied to adjoining plates. In the past, a number of approaches have been tried to increase turbulence, but the results have been limited due to the difficulty in manufacturing plates that create a great deal of turbulence. It would be desirable to for electrode plates to have a design that maximizes turbulence yet is easy to manufacture.

Typically, a reaction chamber has a compromise design to accommodate different aspects of the electrolytic process. Primarily, the chamber must be effective and efficient in its performance. Thus, such aspects as electrode composition, spacing, uniformity of spacing, and surface area are considered. Sustainable spacing between electrodes is important, so that adjacent electrodes do not contact each other and thereby produce a short circuit.

A non-uniform spacing between juxtaposed electrode plates can lead to accelerated consumption of the electrodes at the closest point, requiring those plates to be prematurely replaced. The flow path through the electrodes is a significant factor, as the length of the path influences the speed with which the reaction must be performed and, thus, influences the electrical requirements of the chamber. Ease of replacing electrodes is significant, both in terms of maintenance cost and the downtime of a reaction chamber. Provision for removing generated gases from the flow path is significant, as pockets of gas can reduce the efficiency of a reaction chamber. These are only a few of the considerations that influence design of reaction chamber, which is a complex process.

A filter-press design is a convenient configuration in terms of assembly and maintenance of a reaction chamber. Electrode plates are interleaved with dielectric spacers and gaskets to form an electrode stack. The stack is capped at its opposite ends by end plates, which are clamped together by a suitable compression device, which may consist of bolts, a piston, or the like. The compression device is tightened to clamp the end plates, in turn squeezing together the elements in the stack of electrodes, gaskets and spacers. The filter-press design often employs a frame to support the electrode stack in alignment, as illustrated by U.S. Pat. No. 5,006,215 to Borrione et al. The filter-press design is desirable because the stack of electrode plates is held as a unit that is easy to handle. Further, the spacing between plates is well controlled. The end plates can be configured for connection to inlet and outlet conduits for feeding and removing a process liquid, and the electrode plates can be suitably apertured or otherwise configured to define a flow path between the electrodes in the stack. A filter-press design lends itself to the use of inexpensive electrode plates having a square or rectangular shape, which is easily fabricated and, therefore, relatively low in cost.

However, even in a filter-press style chamber, the electrode stack can be time consuming to assemble, disassemble, and maintain. Numerous gaskets, spacers, and electrodes often are a part of the stack and are difficult to arrange with perfection, such that the stack has no leaks. Each time an electrode stack is disassembled for service, gaskets tend to fall from their proper positions and are time consuming to reposition. Even gaskets that were initially adhered in place can become dislodged after use. Upon reassembly, some of the gaskets may fail to reseal. The filter-press design can overcome part of this problem with its ability to apply high forces to compress the stack and seal leaks. However, overly high compression forces can become another cause of premature gasket failure.

U.S. Pat. No. 1,541,947 to Hartman et al (1922) shows an early attempt at constructing such a filter-press style reaction chamber. An electrode stack is formed of rectangular plates. Alternate plates are apertured near opposite narrower ends of the rectangle. Notably, two apertures are used at the perforated end of each rectangle. These apertures are transversely oblong, such that a considerable percentage of the perforated end is open for liquid flow from one processing chamber or zone to the next. Thus, the electrode stack defines a sinuous, longitudinal flow path from edge-to-edge of the rectangle, with the direction of flow reversing in each successive zone as the process liquid flows through the series of processing zones.

Later advances in chamber design reveal that edge-to-edge sinuous flow across a rectangle is not uniform. Fluid in certain areas between the electrodes will be stagnant, allowing precipitates to foul nearby surfaces of the electrodes. U.S. Pat. No. 4,124,480 to Stevenson discloses this problem in a filter-press design that employs edge-to-edge flow over rectangular plates in an electrode stack. The electrode plates are slotted across the full width of alternating narrow ends to encourage the process liquid to flow over the full width of each electrode plate. However, even passing through a full width slot, the liquid stagnates along the edges of the plates, perhaps because of resistance induced by contact with the gasket or spacer located at such edges. Thus, it appears likely that longitudinal flow over a rectangular plate bounded by a sidewall will be non-uniform and will result in fouling of certain areas of the plates.

The Stevenson patent proposes a filter-press design using an alternate flow pattern with square electrode plates forming square treatment chambers. A first group of electrode plates are apertured at their center. A second group of electrode plates are relatively smaller in size than the first, such that they leave an almost continuous peripheral gap between each of the second group plates and the stack gaskets. In the second group, only the corners of the periphery are engaged between the gaskets and secure the second plates in the stack. The plates of the two groups are arranged in the stack in alternating sequence. The resulting flow path is from the center of a plate in the first group to the periphery of a plate in the second group, and vice versa. This flow pattern can be referred to as a peripheral-to-center pattern.

Such center-to-periphery and periphery-to-center flow will be non-uniform when square treatment chambers are used. In a stack of square plates, the shortest flow path, and likely the one with least resistance, is between the center hole of one plate and the midpoint along any of the four edges of a juxtaposed plate. Fouling is likely along the relatively longer flow paths near the corners of all plates in the stack, with resulting uneven wear, poorly predictable process control, higher electricity usage, short circuits, and premature plate replacement or maintenance.

Fabricating and assembling an electrode stack of circular plates is likely to be more expensive and will not solve all problems of premature fouling. Like square plates, circular plates are configured with portions that engage the stack gaskets; and they must provide apertures or peripheral gaps that establish a sinuous flow path between plates. A circular shape is little better than a square one in meeting these two requirements. Uneven flow paths or stagnant areas are inevitable results. Circular plates are likely to behave similarly to square plates in suffering prematurely fouled areas.

U.S. Pat. No. 4,891,117 to Gardner Sr. illustrates an additional problem with filter-press reaction chambers. A gasket typically is required between elements in the electrode stack, such as between each electrode plate and each spacer or end plate. The gaskets must be aligned accurately to prevent leaks due to irregularities in the stack. Hence, Gardner provides a gasket carrier that delivers a precisely located gasket to the stack. The carrier achieves accurate placement by resting on a pair of dielectric rails as commonly employed in filter-press reaction chambers. While this carrier offers a method of accurate gasket placement, it demonstrates a highly labor intensive and therefore expensive method of assembling the electrode stack.

U.S. Pat. No. 4,589,968 to Toomey, Jr. shows a filter-press reaction chamber with an internal manifold formed of aligned openings in a series of juxtaposed plates. Individual distributor plates define a cross-flow channel between electrode surfaces. An inlet opening receives process fluid from an intake side of the manifold, directs the fluid through a narrow inlet channel leading into an areas of diverging flow path, which in turn directs the fluid into a reaction chamber between electrode plates. The process fluid exits the reaction chamber through a converging flow path, leading to a narrow outlet channel, in turn feeding an outlet opening that is aligned with a discharge side of the manifold. The flow path is linear, between a single inlet and a single outlet in each cell, and alignment with intake and discharge manifolds is required.

Published United States Patent Application 2003-0070919 to Gilmore shows a non-fouling flow path in an electrode cell using the peripheral-to-center flow pattern. This pattern is especially desirable because it utilizes efficient, symmetrical electrode plates. Further, alternating flow between a center aperture in one plate and several peripheral apertures in another can produce improved turbulence.

It would be desirable to overcome existing limitations in reaction chambers of the filter-press design. In particular, it would be desirable to increase the degree of turbulence in the process fluid to further reduce fouling. This result would better enable the reaction chamber to be operated with sustained process efficiency over a predictable interval. Ideally, the reaction parameters of the chamber should determine the consumption of the electrodes. As chamber design improves, maintenance or replacement operations can be performed at calculated, scheduled intervals, allowing a high degree of confidence that the electrocoagulation process will remain effective and efficient between such services.

Further, it would be desirable to construct an electrocoagulation chamber in such a way that assembly and disassembly can be conducted under optimal circumstances; and further, operation of the chamber can be conducted under optimal circumstances. These two interests compete. It would be desirable for a single chamber to accommodate both interests

To achieve the foregoing and other objects and in accordance with the purpose of the present invention, as embodied and broadly described herein, the electrocoagulation chamber and method of this invention may comprise the following.

### BRIEF SUMMARY OF THE INVENTION

Against the described background, it is therefore a general object of the invention to provide a reaction chamber that can be operated to treat a stream of process liquid with upward vertical flow while allowing the electrodes to be serviced in horizontal position.

According to the invention, an electrocoagulation reaction chamber for performing the electrolytic treatment of a stream of process liquid includes an electrode stack containing a plurality of electrode plates and defining a flow path through said electrode stack for passage of a stream of process liquid to be treated. A supporting frame carries the electrode stack. A base carries the supporting frame for pivotal movement with respect to said base. The electrode stack can be disposed in at least two pivotal positions with respect to the base. In a first of the two positions, the electrode stack is substantially horizontal. In a second of the two positions, the electrode stack is substantially vertical. Thus, the electrode stack can be disposed in the first position for maintenance and can be disposed in the second position for conducting electrolytic treatment of a stream of process liquid.

According to another aspect of the invention, the electrocoagulation reaction chamber includes first and second end plates arranged at opposite respective ends of the electrode stack. The first end plate includes a liquid inlet port and the second end plate includes a liquid outlet port. The first end plate is located at an end of said electrode stack that is disposed at the bottom of the electrode stack when the electrode stack is in vertical position. Thus, during electrolytic treatment of a stream of process liquid, the stream of liquid flows from bottom to top of the electrode stack.

According to a further aspect of the invention, an electrocoagulation reaction chamber forms an electrode stack of at least first and second electrode plate assemblies in face-to-face alignment. The first plate assembly includes a first reactive metal plate suited for use in an electrolytic reaction, a first peripheral extension formed of nonreactive material, and an integral interplate spacer formed of nonreactive material and defined on at least one major face of the first plate assembly. The second plate assembly includes a reactive metal plate suited for use in an electrolytic reaction and a second peripheral extension formed of non-reactive material and suitably configured to abut the integral interplate spacer of the first plate assembly.

According to a method of the invention, a stream of process liquid is treated by electrocoagulation. A first step provides a base suited to carry an electrode stack for pivotal movement between a horizontal position and a vertical position. The electrode stack is assembled on the base in horizontal position. The assembled electrode stack includes an inlet end for receiving a stream of process liquid and an outlet end for discharging the stream of process liquid. The inlet end is positioned with respect to the base such that the inlet end is at the bottom of the assembled electrode stack when the electrode stack is pivoted to vertical position. A source of electric current is provided to the electrode stack for treating process liquid passing through the stack. The assembled electrode stack is pivoted into a vertical position with the inlet end at the bottom of the stack. The stream of process liquid is directed into the electrode stack through the inlet end for treatment during upward flow. The stream of process liquid is treated while in the electrode stack by application of electric current from the current source to the electrode stack. The process liquid is discharged from the outlet end of the stack. Then, the electrode stack is pivoted from vertical to horizontal position and disassembled.

The accompanying drawings, which are incorporated in and form a part of the specification, illustrate preferred embodiments of the present invention, and together with the description, serve to explain the principles of the invention. In the drawings:

### BRIEF DESCRIPTION OF THE SEVERAL VIEWS OF THE DRAWINGS

FIG. 1 is a side elevational view of a reaction chamber in horizontal position.

FIG. 2 is a end elevational view thereof.

FIG. 3 is a side elevational view of the reaction chamber in vertical position.

FIG. 4 is a top plan view thereof.

FIG. 5 is a front elevational view of an electrode plate assembly of a first configuration.

FIG. 6 is a cross-sectional view taken along the plane of line 5-5 of FIG. 4.

FIG. 7 is a front elevational view of an electrode plate assembly of a second configuration.

FIG. 8 is a cross-sectional view taken along the plane of line 7-7 of FIG. 6.

### DETAILED DESCRIPTION OF THE INVENTION

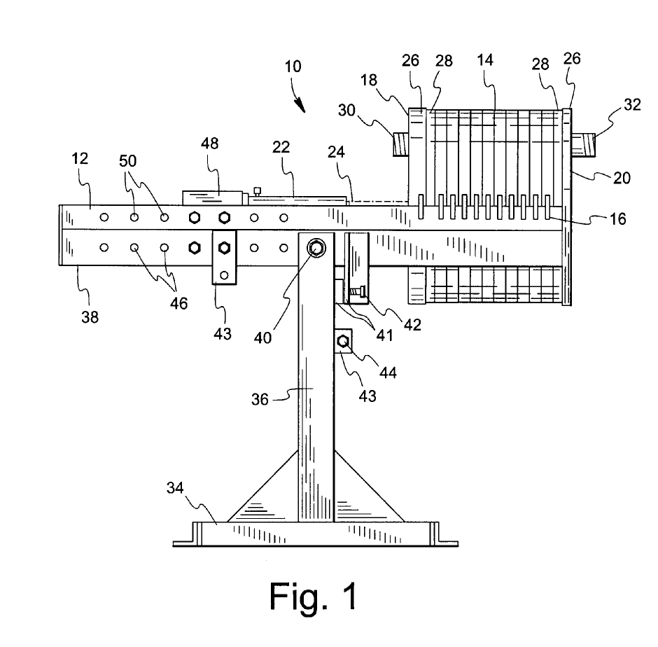

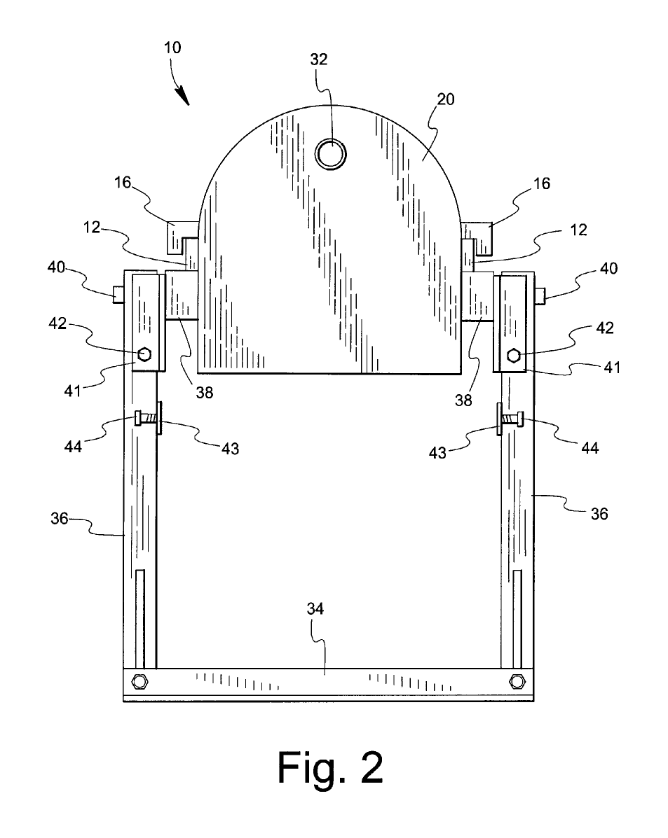

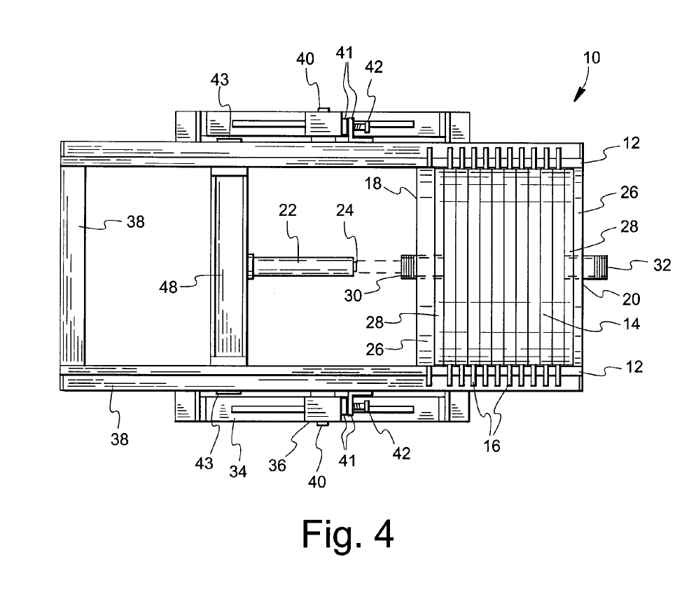

The invention is an improved reaction chamber 10 for treating a stream of process fluid by an electrocoagulation reaction. With reference to FIGS. 1-4, the reaction chamber 10 employs a filter press style frame in which side rails 12 of predetermined length support an electrode stack 14 consisting of an array of electrode plate assemblies. Each plate assembly is configured to have a pair of hanging ears 16, best shown in FIGS. 2, 6, and 8, for suspending the plate on the rails 12. The ears 16 may be constructed from a dielectric material to insulate the plates from the frame and from one-another.

The frame carries the plate stack 14 between an opposed pair of end plates 18, 20. A first one of the end plates 18 is selectively moveable both toward and away from the second, such as by engaging the side rails 12 by hanging ears 16 similar to those found on the electrode plate assemblies. The second end plate 20 may be stationary with respect to the side rails 12, such as by fixed attachment to the frame. A pressure applicator 22 such as a mechanical press or a hydraulic cylinder controls movement of the first end plate 18 and, in turn, the electrode plate assemblies. FIGS. 1, 3, and 4 show the pressure applicator to be a hydraulic cylinder 22 with an extended piston 24 illustrated in phantom in a position compressing end plate 18 against the electrode stack 14.

Each end plate may include both an outer pressure plate 26 and an inner sealing plate 28. The pressure plate 26 may be buttressed and reinforced as suitable to apply uniform sealing pressure against the plate stack 14 when the pressure applicator applies pressure against the plate stack. The inner sealing plate 28 is formed of a suitable material for sealing against the plate stack. This material may be a synthetic plastic or elastomeric material.

The first end plate 18 is provided with an inlet fitting 30 or other conduit suited for attachment to further inlet conduit as required for transmitting fluid into the reaction chamber plate stack 14. The conduit or fitting 30 provides an inlet port for receiving fluid to be treated in the reaction chamber 10. The port passes through both the outer pressure plate 26 and the inner sealing plate 28 of end plate 18. The inner sealing plate may have a suitably channeled, grooved, or otherwise configured face to allow fluid communication between the inlet port and the fluid passages in any design of electrode plates in the plate stack 14, as described below. At least a portion of the inlet conduit is preferred to be flexible to allow pivotal movement of the electrode stack 14 between substantially horizontal position and substantially vertical position.

The second end plate 20 is provided with an outlet fitting 32 or conduit providing an exit port from the reaction chamber. End plate 20 is stationary with respect to the frame. The pressure plate portion 26 of end plate 20 may be attached to the frame, while inner sealing plate 28 of plate 20 serves a sealing function against the juxtaposed electrode of the electrode stack. The exit port established by fitting 32 passes through both portions of end plate 20. The inner opening of the exit port is in fluid communication the fluid flow path through plate stack 14. Conduit or fitting 32 is suited for attachment to a further outlet conduit as required for discharging treated fluid. At least a portion of the outlet conduit should be flexible to accommodate the described pivotal movement of the reaction chamber.

In the context of this disclosure, the angular disposition of an electrode stack 14 is determined by the direction of alignment between assembled electrode plates defining the stack. In a horizontal stack, the electrode plates are arranged face-to-face in a substantially horizontal row. In a vertical stack, the electrode plates are arranged face-to-face in a substantially vertical column. Various means may selectively secure the electrode stack 14 in vertical, horizontal, or other angularly disposed position. The electrode stack can be disposed in at least two available positions. A horizontal or other relatively lowered position is available. A vertical or other relatively raised position also is available.

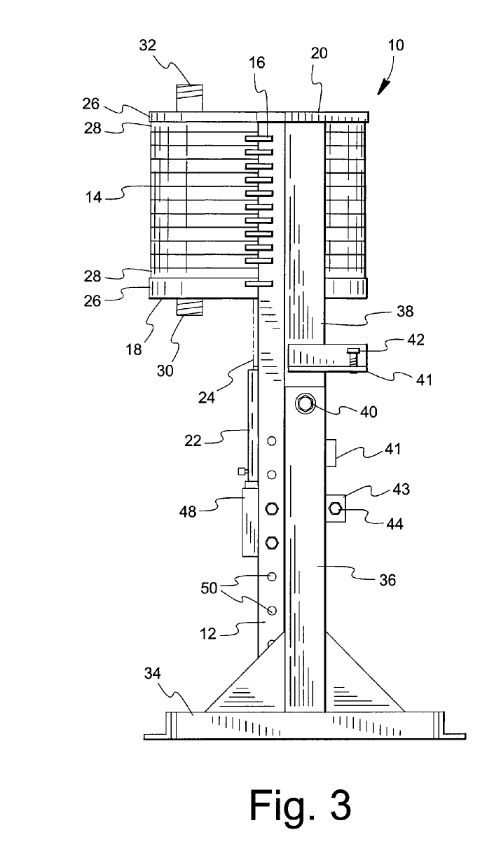

A base 34 supports the frame. Side support legs 36 extend upright from the base 34 to carry the side rails 14. The side supports 36 may be connected to top frame 38 that directly carries the rails 12. Each side support 36 is connected to the top frame 38 by a suitable mechanism that allows rotation of the top frame 38 and plate stack 14 between available positions, which preferably include vertical and horizontal positions. A suitable, rotatable mechanism may include a pin, shaft, or hub, illustrated as a pair of bolts 40 providing bolt shafts on opposite sides of the frame, allowing pivotal motion between the side supports and the top frame on a transverse, approximately horizontal pivot axis extending between the opposite the bolt shafts 40. Bolt shafts 40 allow side rails 14 and top frame 38 to be swung between a horizontal or lowered position as shown in FIGS. 1, 2, and 4 and a vertical or raised position shown in FIG. 3.

A horizontal or lowered position pivot stop is suitably positioned to support the top frame 38 in horizontal or other lowered position. As best shown in FIG. 1, the horizontal pivot stop provides abutting stop members 41 on top frame 38 and side supports 36 to support the top frame 38 horizontally against the weight of the plate stack 14 at one end of the top frame. An optional variable length element such as a bolt 42 extends through one of the abutting members 41 and establishes a variably selected distance between the abutting members 41 for fine adjustment of the lowered or horizontal position. Optionally, the bolt 42 or other type of latch can secure the frame in horizontal or lowered position by locking together the two abutting members of the pivot stop 41. However, this has proven to be unnecessary because the mass of the plate stack 14, in the illustrated position at the end of the frame 38, is sufficient to prevent the frame from tilting inadvertently from such a lowered position.

A vertical or raised position pivot latch is suitably positioned to support the top frame 38 in vertical or raised position. As best shown in FIGS. 1 and 3, the vertical pivot latch provides latch plates 43 having alignable bores. As top frame 28 swings from lowered to raised or vertical position, latch plates 43 on top frame 38 swing with the top frame into aligned position with matching latch plates 43 on side supports 36. A locking element such as a pin or bolt 44 can be placed through the aligned bores to lock the top frame in vertical or raised position.

The top frame 38 provides a series of alternate junction locations by means of a series of pivot pin reception bores 46 located along the longitudinal length of the top frame. A cross-brace 48 is attached between the sides of the top frame to suitably support the pressure applicator 22 at a central position. The pressure applicator 22 is selectively connected to the rails 12 or top frame 38 by cross brace 48 at any of a series of spaced bolt holes 50, allowing the pressure applicator 22 to be longitudinally relocated to accommodate different numbers of plates in the reaction chamber 10. The capability to secure the reaction chamber in horizontal, vertical, or other angular positions allows the reaction chamber to be operated in a near-vertical position and serviced in a near-horizontal position, or in such other different positions as my be selected. As shown in FIG. 3, a vertical position of the reaction chamber places the inlet fitting 30 at the bottom of the reaction chamber so that fluid flows upward during use. This position allows gases to rise due to buoyancy and direction of fluid flow and to exit the chamber through exit fitting 32.

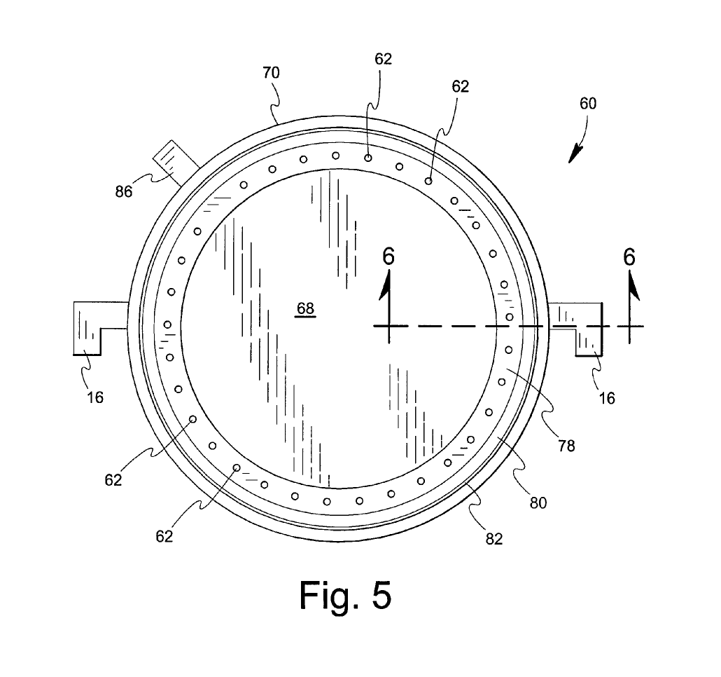

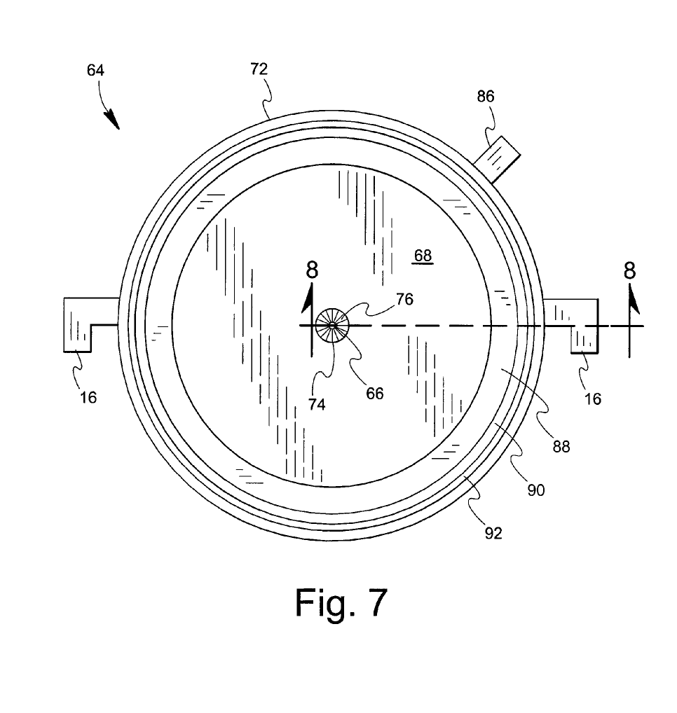

The best mode of structuring the reaction chamber 10 is with a series of electrode plate assemblies having at least two different configurations, arranged in alternating sequence. A first plate assembly 60 of FIG. 5 is configured to have an array of fluid passages 62 located near the periphery of the plate. A second plate assembly 64 of FIG. 7 is configured to have a central fluid passage 66. Arranging the first and second plate assemblies 60, 64 in alternating sequence establishes a known, desirable flow path through the reaction chamber plate stack 14, with the flow following a serpentine path between the periphery and the center of alternate plates.

Each of the first and second electrode plate assemblies 60, 64, includes both a reactive plate 68 and one or more associated dielectric, nonreactive plate extensions that define the fluid passages 62, 66. The reactive plate 68 typically is formed of metal, such as hot rolled mild steel, selected for suitability to participate in an electrolytic reaction. Such plates can be formed efficiently and inexpensively in simple planar geometric shapes such as squares, rectangles, and circles.

First plate assembly 60 includes a peripheral, outward plate extension 70 that defines first, peripheral apertures 62. Second plate assembly 64 includes a similar peripheral outward plate extension 72, but without apertures 62. The plate extensions 70, 72 each surround the entire peripheral minor edge of a reactive plate 68.

Plate assembly 64 also defines a central hole 74 and carries an inwardly extending plate extension 76 that lines the central hole 74 in the plate assembly 64 and defines the central aperture 66. For example, central hole 74 is round, extension 76 is a disk that fits the round hole 74, and aperture 66 is a central hold in disk 76 of smaller diameter than the disk 76. Thus, the central inward extension 76 is located in a central opening 74, within the reactive plate 68 of plate assembly 64, and serves as an inward extension of the plate that reduces the size of the central opening 74. The central extension 76 serves as a liner that protects the minor edge of the central opening 74 from wear during the electrolytic reaction. The apertures in the plate extensions 70, 76 are substantially impervious to wear and enlargement during the electrocoagulation process because the material of the extensions is not reactive in the electrocoagulation reaction process.

The plates and nonreactive extensions are manufactured as permanently combined units by a molding process. Accordingly, the minor edges of the reactive plates 68 are protected from wear by the molded-on extensions. As a result, the major faces of the plates 68 will wear with improved predictability of rate, and the reaction rate will continue without unexpected rate changes caused by wear or degradation at the apertures or edges.

With reference to FIGS. 5 and 7, the nonreactive extension members 70, 72, and 76 are formed of a synthetic, flexible and resilient material. The preferred material is a wear resistant urethane polymer sold under the trademark, Nataprene by Nataprene Corporation of 217 Atlantic Avenue, McKeesport, Pa. 15132-3812. This material cures as a strong, rubbery solid having a hardness of ninety, high tensile strength and resilience, excellent resistance to abrasion, compression set, oils, water, solvents, oxidation, ozone, low temperatures, and fungus and mildew growth. The bond strength of Nataprene against steel or aluminum exceeds the cohesive strength of the Nataprene itself.

By suitable configuration of these peripheral ring extensions 70, 72, and 76, the reactive plates 68 are spaced apart at predetermined distances without requiring the addition of separate spacers. Peripheral ring extensions 70 and 72 also serve as face-to-face seals for the first and second plate assemblies 60, 62 at their peripheries in the electrode stack 14 without requiring the use of separate seals or gaskets. Optionally, the peripheral ring extensions 70, 72 are configured with engaging structures to form special seals or are configured with carrier structures for receiving, positioning, and retaining separate gaskets or seals.

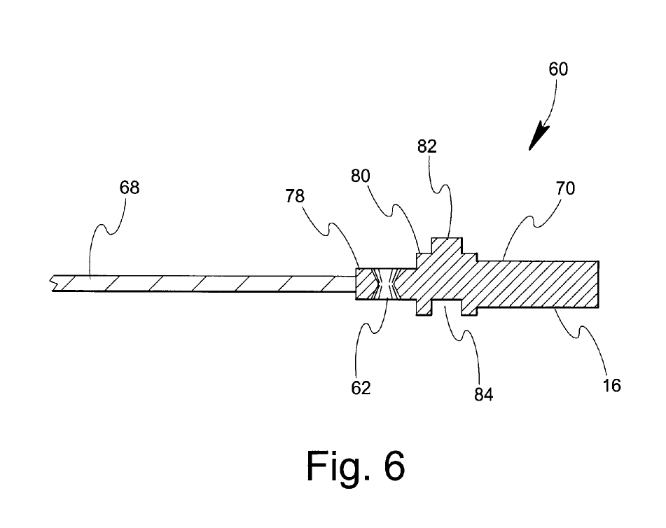

As best shown in FIG. 6, the extension ring 70 covers the peripheral edge of a reactive metal plate 68 of first plate assembly 60. The extension ring 70 is thicker than the plate 69 and may include several concentric annular areas of different thickness. A typical reactive metal plate 68 may have a thickness of about 0.25 inches. Immediately juxtaposed to the bonded border with metal plate 68, a first annular portion 78 of ring 70 may have a minimum thickness such as 0.5 inches. First annular portion 78 defines the apertures 62, which are molded into extension ring 70. A second sequentially outward annular ring portion 80, which serves an in integral interplate spacer, steps to a greater thickness such as 1.0 inch. The spacing established by spacer ring 80 ensures the apertures 62 will have sufficient entrance and exit room for the process fluid to flow through the cells within the electrode stack 14.

Optionally, annular portion 80 may carry an axially protruding rib 62 on one face and an axially recessed groove 84 on the opposite face. The rib and groove are sized to engage snugly, such that in an electrode stack 14 using extension rings with similar rib and groove structures, the rib of one plate assembly fits the groove of the facing assembly to create a leak proof, labyrinth seal. Thus, the plate assemblies 60 each carry both an integral interplate seal structure and an integral interplate spacer structure formed as part of the extension ring 70. Notably, the extension ring 70 has been found to readily establish a leak proof seal when compressed in the electrode stack without requiring use of the optional structures 82, 84. The Nataprene material or another material having characteristics similar to Nataprene establishes the seal.

The greater thickness of ring 70 above the thickness of plate 68 allows the ring 70 to coat both faces of a radially extending electrical connection tab 86, best shown in FIGS. 5 and 7, of each metal plate 68. The tab extends through the ring 70 and provides an attachment point for applying current to the plate 68. The hanging ears 16 that support each plate on rails 12 are parts of the respective molded extension ring 70, 72. The use of a non-conductive material in the extension rings as ears 16 simplifies the job of electrically isolating each metal plate 68.

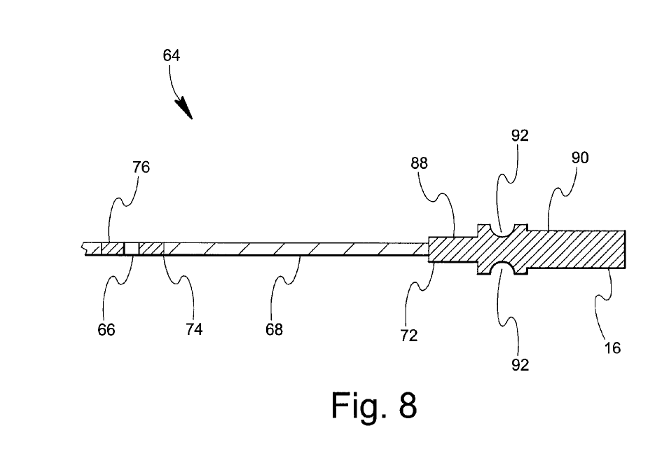

As best shown in FIG. 8, the extension ring 72 covers the peripheral edge of a reactive metal plate 68 in plate assembly 64. The extension ring 72 is thicker than plate 68 and may include several concentric annular areas of different thickness. Immediately juxtaposed to the bonded border with metal plate 68, the ring 72 may include a first annular portion 88 of a minimum thickness such as 0.5 inches. A second, radially outward annular portion 90 steps to a greater thickness such as 0.75 inches. Optionally, annular portion 90 may define an O-ring carrier 92 on both faces of annular portion 90. Each O-ring carrier is configured to receive less than one-half the thickness of an O-ring seal, such that in the electrode stack 14 formed of plate assemblies 60, 64 both having similar carriers 92, the O-ring carrier 92 of one plate assembly fits against the O-ring carrier 92 of a facing assembly to receive and slightly compress an O-ring seal between plate assemblies. The O-ring carriers 92 or second annular portions 90 of neighboring plate assemblies 60, 64 will contact each other and serve as spacers between plate assemblies. The O-ring carriers may have a thickness of 1.0 inch in each extension ring 72. Thus, the plate assemblies 64 each carry a spacer structure formed integrally as part of the ring 72 and provide an integral seal or carrying structure for an optional gasket.

Plate assembly 64 also carries a molded ring 76 in a hole at the center of the plate 68. The central molded ring 76 is of approximately the same thickness as the metal plate 68. Thus, in an electrode stack 14, the central molded ring 76 is spaced from the next facing plate by about the same distance as the metal plate 68 that carries the molded ring 76. The preferred material for ring 76 is Nataprene, as described above. The central ring 76 and the peripheral ring 72 are molded to the metal electrode 68 in a single molding operation. Apertures 62, 66, are molded respectively into central ring 76 and peripheral ring 70 during a single molding process.

The different details of the optional seal or gasket structures in the extension rings of FIGS. 6 and 8 provide alternatives for purposes of illustration and should not be intermixed. The electrode plate assemblies chosen to form a single electrode stack 14 should all employ the same type of seal. Thus, if optional seals are used, the alternating plate assemblies 60, 64 both should employ the rib-and-groove seal of FIG. 6; or both should employ the O-ring and carrier structure of FIG. 8.

In an assembled electrode stack 14, the alternating plate assemblies 60, 64, define reaction cells between each pair of facing plate surfaces. The alternating plate assemblies 60, 64 will direct the process fluid in a radial path across the facing surfaces of the reactive plates 68 in each cell. Radial flow will alternate directions in sequential cells, from the peripheral apertures 62 to the central aperture 66 and vice-versa.

The apertures 62, 66, should be sized to cause variations in velocity as the process fluid flows through the electrode stack 14. The center aperture 66 of one plate assembly should have a different area than the total area of the peripheral apertures 62 in a juxtaposed plate assembly. This area difference should be sufficient to cause a change in velocity as the process liquid passes through different sized holes. The process liquid should thereby be placed in turbulent flow to increase reaction rate, clean the plates, and reduce or eliminate the double electrical boundary effect.

The use of a venturi configuration in various apertures or passages throughout the reaction chamber enhances the level of turbulence. The venturi profile is molded into apertures 62 and 66. The inlet aperture in end plate 18 also may have a venturi throat to cause the incoming process fluid to enter the reaction chamber plate stack 14 with turbulent flow.

In assembly and operation, the reaction chamber 10 is formed by assembling an electrode stack 14 on rails 12 while the frame 38 is disposed horizontally or in other lowered position as illustrated or suggested by FIGS. 1 and 2. Electrode plate assemblies 60, 64 are arranged in alternating sequence by placing the plate assemblies between end plates 18, 20. Should additional spacers be desired, the spacers may resemble the peripheral extension rings 70 or 72, as appropriate to the selected type of seal. A mechanical, hydraulic, or other pressure applicator 22 presses end plate 18 against the electrode stack, pressing the plate assemblies together as allowed by the integral or optional spacers 80, 92. At the same time, the plate assemblies are sealed against each other by the integral gaskets established by a Nataprene-type of material or by optional seals 82, 84, or by separate O-rings in O-ring carriers 92. The plate assemblies are connected to a source of current at tabs 86, as desired to conduct an electrocoagulation reaction. An inlet conduit is attached to end plate 10 and an outlet conduit is attached to end plate 20.

After the reaction chamber 10 has been assembled and properly connected to electrical and fluid sources, the pivot stop 41 is disengaged, if necessary, and the frame is pivoted on pivot pins 40 from a lowered or horizontal position to a raised or vertical position. In the raised or vertical position of FIG. 3, latch plates 43 can be secured in aligned position by lock elements 44 to secure the frame in vertical or raised position. Process fluid enters from the bottom of the electrode stack 14, such as through a suitable inlet port via a suitable fitting 30 or conduit supplying process liquid through bottom end plate 18. Flow through the stack 14 is from bottom to top and in a serpentine path, side-to-center in one cell and center-to-side in the next cell. Treated process fluid exits from the top of the electrode stack 14, such as through a suitable outlet port fitting 32 or conduit in top end plate 20. The vertical flow pattern has the advantage that gases generated in the reaction will tend to rise with the flow of process fluid and exit the electrode stack 14. A reduced amount of trapped gas correspondingly reduces floc buildup that otherwise tends to accumulate at the bottom of a horizontal flow chamber.

At the conclusion of processing, or when maintenance is to be performed, the vertical or raised position lock elements 44 are released and the frame 38 is swung back to horizontal or lowered position on pivot pins 40. Horizontal pivot stops 41 engage to support the frame in horizontal or lowered position. The pressure applicator 22 is released, allowing the plate assemblies 60, 64 to be separated. Electrical connections are removed from the tabs 86 as required. The unitary plate assemblies 60, 64, then can be removed from the electrode stack 14 as desired for service or replacement.

The ability to adjust the angular position of the reaction chamber plate stack 14 provides several additional advantages. A drain valve can be attached to first end plate 18, which is the bottom end plate when the chamber is disposed vertically. The drain valve can effectively drain the full contents of the reaction chamber 10 prior to servicing. A horizontal chamber cannot be drained with equal efficiency because individual cells will pocket the process fluid. Thus, when a horizontal reaction chamber is opened for service, a considerable quantity of process fluid spills from it. A vertical flow reaction chamber 10 also enables the use of a test port on the top end plate 20 for drawing samples in order to optimize the power settings and fluid velocity.

Where the description lists various specific details and dimensions, it should be understood that these are for purposes of illustration and not limitation. Further, the reactive plates 68 and plate assemblies 60, 64, have been described and shown as disks having annular features. Many other shapes can be used with equivalence, including squares and rectangles. For example, the plate extensions 70, 72 may be given square or rectangular features and outside edge profiles. Similarly, the reactive plates 68 may be of square, rectangular, or other profile, including round plates 68 molded into square or rectangular extensions 70, 72.

The foregoing is considered as illustrative only of the principles of the invention. Further, since numerous modifications and changes will readily occur to those skilled in the art, it is not desired to limit the invention to the exact construction and operation shown and described, and accordingly all suitable modifications and equivalents may be regarded as falling within the scope of the invention as defined by the claims that follow.

What is claimed is:

1. An electrocoagulation reaction chamber for performing the electrolytic treatment of a stream of process liquid, comprising:
an electrode stack containing a plurality of electrode plates and defining a flow path through said electrode stack for passage of a stream of process liquid to be treated;
a supporting frame carrying the electrode stack; and
a base carrying said supporting frame for pivotal movement with respect to said base, such that the electrode stack can be disposed in at least two pivotal positions with respect to the base, wherein a first of said two positions is substantially horizontal and the second of said two positions is substantially vertical;
whereby the electrode stack can be disposed in said first position for maintenance and can be disposed in said second position for conducting electrolytic treatment of a stream of process liquid.

2. The electrocoagulation reaction chamber according to claim 1, further comprising:
first and second end plates arranged at opposite respective ends of said electrode stack; and
a liquid inlet port in said first end plate and a liquid outlet port in said second end plate;
wherein said first end plate is located at an end of said electrode stack that is disposed at the bottom of the electrode stack when the electrode stack is in said second position, such that during electrolytic treatment of a stream of process liquid, the stream of liquid flows from bottom to top of the electrode stack.

3. The electrocoagulation reaction chamber according to claim 1, wherein said electrode stack comprises:
at least first and second electrode plate assemblies in face-to-face alignment;
and wherein:
said first plate assembly includes a first reactive metal plate suited for use in an electrolytic reaction, a first peripheral extension formed of nonreactive material, and an integral interplate spacer defined on at least one major face thereof and formed of nonreactive material; and
said second plate assembly includes a reactive metal plate suited for use in an electrolytic reaction, and a second peripheral extension formed of nonreactive material and suitably configured to abut said integral interplate spacer of said first plate assembly.

4. The electrocoagulation reaction chamber of claim 3, wherein said nonreactive material of said first and second peripheral extensions further comprises a cured urethane polymer of high bond strength to steel.

5. The electrocoagulation reaction chamber of claim 3, wherein said first and second peripheral extensions are formed of a cured urethane polymer of a bond strength to steel that exceeds the cohesive strength of said cured urethane polymer.

6. The electrocoagulation reaction chamber of claim 3, wherein said integral interplate spacer further comprises a molded portion of said first peripheral extension.

7. The electrocoagulation reaction chamber of claim 6, wherein said integral interplate spacer carries an integral interplate seal.

8. The electrocoagulation reaction chamber of claim 3, wherein said first and second peripheral extensions further comprise an interplate seal having integral mating portions thereof on each of the first and second peripheral extensions.

9. The electrocoagulation reaction chamber of claim 3, wherein:
said first peripheral extension defines a plurality of apertures arranged outside the periphery of said first reactive plate for passing a fluid near the periphery of said first plate assembly; and
said second reactive plate defines a central aperture for passing fluid near the center of the second plate assembly;
whereby a reaction chamber formed of said first and second plate assemblies in face-to-face juxtaposition establishes a flow path between the periphery of the first plate assembly and the center of the second plate assembly.

10. The electrocoagulation reaction chamber of claim 9, wherein:
said second reactive plate defines a central opening; and
a liner formed of nonreactive material covers the edge of said central opening and defines said central aperture.

11. A method of treating a stream of process liquid by electrocoagulation, comprising:
providing a base suited to carry an electrode stack for pivotal movement between a horizontal position and a vertical position;
assembling a plurality of electrode plates to form said electrode stack on said base in said horizontal position, wherein the assembled electrode stack includes an inlet end for receiving a stream of process liquid and an outlet end for discharging said stream of process liquid; and wherein said inlet end is positioned with respect to said base such that the inlet end is at the bottom of the assembled electrode stack when pivoted to said vertical position;
providing a source of electric current to said electrode stack for treating process liquid passing therethrough;
pivoting said assembled electrode stack into a vertical position with said inlet end at the bottom of the stack;
directing said stream of process liquid into the electrode stack through said inlet end for upward flow;
treating said stream of process liquid while in the electrode stack by applying electric current from said source thereof to plates of the electrode stack;
discharging process liquid from said outlet end;
pivoting the electrode stack from vertical to horizontal position; and
disassembling the horizontal electrode stack.

12. An electrocoagulation reaction chamber, comprising:
at least first and second electrode plate assemblies in face-to-face alignment;
said first plate assembly includes a first reactive metal plate suited for use in an electrolytic reaction, a first peripheral extension formed of nonreactive material, and an integral interplate spacer defined on at least one major face thereof and formed of nonreactive material; and
said second plate assembly includes a reactive metal plate suited for use in an electrolytic reaction, and a second peripheral extension formed of nonreactive material and suitably configured to abut said integral interplate spacer of said first plate assembly.

13. The electrocoagulation reaction chamber of claim 12, wherein said non-reactive material of said first and second peripheral extensions further comprises:
a cured urethane polymer of high bond strength to steel.

14. The electrocoagulation reaction chamber of claim 12, wherein said first and second peripheral extensions are formed of a cured urethane polymer of a bond strength to steel that exceeds the cohesive strength of said cured urethane polymer.

15. The electrocoagulation reaction chamber of claim 12, wherein said integral interplate spacer further comprises a molded portion of said first peripheral extension.

16. The electrocoagulation reaction chamber of claim 15, wherein said integral interplate spacer carries an integral interplate seal.

17. The electrocoagulation reaction chamber of claim 12, wherein said first and second peripheral extensions further comprise an interplate seal having integral mating portions thereof on each of the first and second peripheral extensions.

18. The electrocoagulation reaction chamber of claim 12, wherein:
said first peripheral extension defines a plurality of apertures arranged outside the periphery of said first reactive plate for passing a fluid near the periphery of said first plate assembly; and
said second reactive plate defines a central aperture for passing fluid near the center of the second plate assembly;
whereby a reaction chamber formed of said first and second plate assemblies in face-to-face juxtaposition establishes a flow path between the periphery of the first plate assembly and the center of the second plate assembly.

19. The electrocoagulation reaction chamber of claim 18, wherein:
said second reactive plate defines a central opening; and
a liner formed of non-reactive material covers the edge of said central opening and defines said central aperture.
